(19) United States
(12) Patent Application Publication
(10) Pub. No.: US 2014/0008869 A1
(43) Pub. Date: Jan. 9, 2014

(54) ACTIVE LEARNING CARD GAME AND METHOD FOR GAME BASED TEACHING AND LEARNING OF PERIODIC TABLE OF CHEMICAL ELEMENTS

(71) Applicants: Ravindran Pulyassary, Kanata (CA); Ajitha T. Marath, Kanata (CA)

(72) Inventors: Ravindran Pulyassary, Kanata (CA); Ajitha T. Marath, Kanata (CA)

(21) Appl. No.: 13/521,042

(22) Filed: Jul. 7, 2012

(51) Int. Cl. G09B 23/24

(52) U.S. Cl. CPC G09B 23/24
USPC 273/296; 273/302

(57) ABSTRACT

An educational card game comprises a set of cards and rules for playing card games using them to facilitate Game Based Teaching and Learning is presented. Each card represents a respective one of the chemical elements listed in the Periodic Table of Chemical Elements. The rules prescribe for cards to be distributed to the players who, in their turns in a particular round of the game, attempt to use the cards to win the round by creating meaningful patterns using the played card or by playing the highest value card in that round, or to spoil the round or to save a round from being spoiled by an opponent and optionally using the earned card to form chemical compounds or to form ironing equations, points being scored according the nature of the cards used or the nature of the compound formed, or both.

### CROSS-REFERENCE TO RELATED APPLICATIONS

This application claims priority from International (PCT) patent application NO. PCT/CA2011/000066, Dated 21 Jan. 2011 entitled “Active Learning system Method, Board Game and Card Games, Game Board and Playing Card for Use Therewith”. The entire contents of the application is incorporated herein by reference.

### TECHNICAL FIELD

This invention relates to games related to chemistry and is especially applicable to card games related to the Periodic Table of Chemical Elements, structure of which was originally devised by Mendeleev and subsequently revised by International Union of Pure and Applied Chemistry (IUPAC)

### BACKGROUND ART

Active learning is generally defined as any instructional method that engages students in the learning process It involves more activity on the part of the leaner than simply listening. The core elements of active learning are student activity and engagement in the learning process. Active learning is often contrasted to the traditional lecture where students passively receive information from the instructor. Most important, to be actively involved, students must engage in such higher-order thinking tasks as analysis, synthesis, and evaluation. Active learning is integral part of Game Based Learning and Teaching Methodology. Without active learning students may not be engaging in learning material beyond simple memorization.

Game based teaching and learning may foster active learning by requiring interactivity, peer-learning and team work, promoting collaboration, and increasing motivation. Game based teaching and learning can be used to address cognitive psychomotor and affective domains of learning and to support different learning styles. Perhaps most significantly, game based teaching and learning s respect a performance-based environment. One can not be passive when playing a game. Learning through performance requires active discovery, analysis, interpretation, problem-solving, memory and physical activity which result in the sort of extensive cognitive process that deeply roots learning in a well-developed neutral network. To some extent, this approach is followed in higher education and professional education, with the teacher or mentor providing guidance.

“Games can help make learning more engaging, relevant and give students real agency in ways that static textbooks simply cannot . . . [they] can help teachers manage large classes with widely divergent student capabilities and learning styles . . . foster critical skills such as problem solving, critical thinking, systems thinking, digital media literacy, creativity and collaboration . . . . Games are also capital efficient, [and] can be deployed, scaled, updated and optimized at a fraction of the per student cost of most textbooks.” From Huffingtonpost Education article “Game-Based Learning: Hype Vs. Reality” posted on Apr. 3, 2011 . . . .

Fundamental science education entails a knowledge of the chemical elements which constitute the building blocks of all matter in the known universe, and the various compounds resulting from chemical reactions between these chemical elements. The Periodic Table of Chemical Elements, structure of which was originally devised by Mendeeleve and subsequently filled by others, which is an integral part of the chemistry curriculum in most schools, is an essential tool for understanding the properties of chemical elements (natural, artificial or whose existence has been predicted) and thousands of chemical compounds resulting from the chemical reactions among them.

In the Periodic Table, chemical elements are grouped on the basis of their properties helps the student to understand and predict the salient and unique features of an element based on the group to which it belongs. Consequently, the Periodic Table is a concise way of communicating the details of an atom of an individual element, such as number of electrons, protons and neutrons, along with the chemical symbol for the element. The position of the element in the periodic table automatically defines the common characteristics of the element and facilitates the prediction of the behavior of the element while forming chemical bonds with other elements. The position in the periodic table also predicts the shell structure for the neutral atom of the element. Clearly, gaining familiarity with, and, if possible getting a clear understanding of the periodic table, would represent a milestone of achievement for any serious student of chemistry.

Understanding the fundamentals of chemistry using the periodic table of elements through a conventional approach of reading and memorizing the chemical properties of various elements and numerous compounds formed by chemical reaction among them is a laborious task. Some students may give up the task soon after they start. Some others may find the study of chemistry uncomfortable or unproductive. Consequently, students are less likely to successfully learn various aspects of chemistry associated with periodic table of elements to a desired or required level of competence. To achieve the desired or required level of competence, it may take much longer to learn the required subject matter than a student is prepared to commit or can afford.

It is known to use chemistry-related educational games to facilitate the study of chemistry, and particularly the Periodic Table. For example, the book “A handbook of game design” by Henry Ellington, Eric Addinall and Fread Percival, 1982. Kogan Page, London, Nichols Publishing Company, New York, discloses a game known as Formulon™ for use in teaching basic inorganic chemistry to pupils aged roughly 13 to 16 years. The game package consists of a pack of 100 cards plus a three page instructional leaflet. Seventy-eight (78) of the cards represent atoms or ions, twenty (20) represent multipliers (by two or by three) while the remaining two cards are jokers that can be used to represent any other card to make up chemical formulae. This card game does not provide complete coverage of the known chemical elements as it is based on a limited set of only 78 atoms or ions of atoms, since the multipliers and jokers do not represent any chemical elements.

EP0023687 is an educational game of cards based on chemistry is realized by two packs of cards on which fancy images and symbols representing chemical elements with their valences and atomic weights are printed. The cards of one pack refer to metals and oxygen, the cards of the other pack refer to non-metals, or metalloids, and oxygen. The game consists in joining together groups of cards of the one or of the other pack, so that these combinations represent the formation of molecules according to the laws of chemistry, on the base of the elements and their valences. The two packs consists of a total of 140 cards, including multiple representation of same element they do not give a full representation of the periodic table of elements. Moreover, many fancy cards are included to facilitate card games. U.S. Pat. No. 7,490,834 disclose chemistry-related board games. US20080284104, though titled as a card game, is a card and board game in which each player executing turns by placing and/or moving one or more of players element cards on a playing surface. The playing card used in this board game has various fictions powers and properties.

Consequently, these known chemistry games in prior arts are not entirely satisfactory learning tools either due to incomplete or unrealistic representation. There remains a need, therefore, for a game that provides a more realistic representation of the Periodic Table and elements represented on it that is suitable for helping students to understand Chemical elements, their properties, and the way in which they may combine to form compounds and ionic equations

### SUMMARY OF INVENTION

A problem to be solved by, or object of, the present invention is to satisfy these needs, at least partially, and at least mitigate the deficiencies of known such games, or at least provide an alternative.

To this end, according to one aspect of the present invention, there is provided an active learning educational card game comprising a set of cards and rules for playing at least one card game using said set of cards, each of said cards representing a respective one of the chemical elements listed in the Periodic Table of Chemical Elements and carrying information about said one of the chemical elements, the set of cards comprising a card for every one of the known chemical elements listed in the Periodic Table of Chemical Elements, the rules prescribing for cards to be distributed to the players who, in their turns in a particular round of the game, attempt to earn cards and/or to form chemical compounds or to form and solve chemical reaction equations with cards, points being scored according the nature of the cards used or the nature of the compound formed, or chemical equation resolved.

In preferred embodiments, the set of cards includes cards for all elements, whether naturally occurring, artificially created or as yet merely predicted.

The rules may prescribe for substitution of cards predefined as equivalent or belonging to a particular group of the Periodic Table of Elements. For example, the rules may prescribe cards to be a globally substitutable, element-substitutable, column-substitutable, row-substitutable, or prescribe other criteria defining a group of cards substitutable with each other

Embodiments of the invention may further comprise a reference listing of chemical compounds to which the players may refer to determine whether or not a combination of cards played by a player do form a recognized compound.

In preferred embodiments of the invention, at least some of the cards carry additional information or insignia and the rules prescribe for the use of those cards to influence the progress of the game. Thus, cards representing radioactive material, such as uranium, may carry a radioactive indicator, such as the symbol used in the nuclear power industry, and the rules may prescribe for such cards to be used to “trump” a particular round of the game.

Advantageously, embodiments of the invention can be used for teaching the periodic table of chemical elements as well as chemical structures and chemical reactions to students with little or no prior understanding of chemistry; or to enhance or reinforce the understanding of chemical elements and chemical reactions possessed by more advanced students of chemistry.

The information carried by the cards may be such that repeated playing of the game may teach the players aspects of all known elements presented in the periodic table, such as the atomic weight, atomic number, name and symbol, the position in the periodic table and what the position means, and/or the valence electron shell structure, through the exposure to these aspects while playing the game. In addition, like a child building a language vocabulary through word games, the game players will be exposed to several chemical compounds and chemical reaction equations through the game. While competing and interacting during the course of the game, the players/students will be exposed to, and may acquire, knowledge about all known basic chemical elements, hundreds of existing known chemical compounds, chemical reactions responsible for compound formation, radioactive elements and noble gases. Embodiments of the invention thus offer an interactive and alternative teaching method to that of common text book memorization to learn about chemical elements and compounds, and the Periodic Table of Elements.

Various objects, features, aspects and advantages of the present invention will become more apparent from the following detailed description, taken in conjunction with the accompanying drawings, of preferred embodiments of the invention, which are described and illustrated by way of example only.

### BRIEF DESCRIPTION OF DRAWINGS

In the drawings, identical or corresponding elements in the different Figures have the same reference numeral.

FIGS. 1A, 1B, 1C and 1D illustrate playing cards representing four chemical elements;

FIG. 2 identify the s-block, p-block, d-block and f-block of elements defined on a Periodic Table of Element.

FIG. 3 identifies the main group metals, the non-metals, the transitional metals and the inner transitional metals defined on a Periodic Table of Elements.

### DETAILED DESCRIPTION OF THE INVENTION

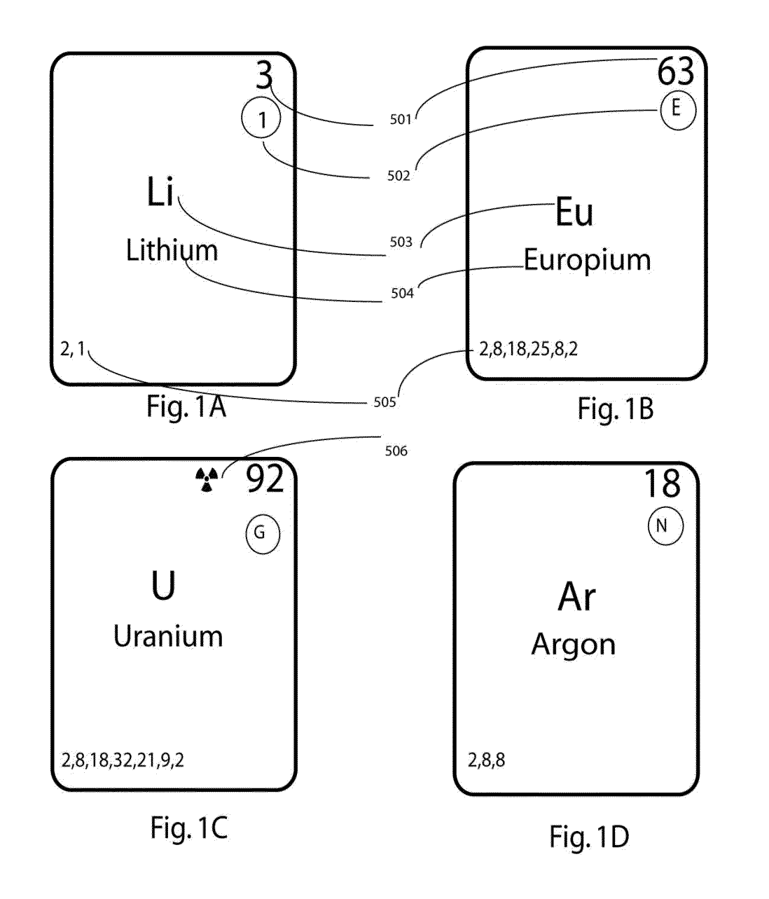

Card games embodying the present invention used for active learning in the area of Periodic Table of Chemical Elements will be played using a deck of cards comprising one or more sets of cards, the cards in the or each set corresponding to respective ones of the chemical elements listed in the Periodic Table, FIGS. 1A, 1B, 1C and 1D show obverse sides of four of those playing cards for the chemical elements Lithium (Li), Europium (Eu), Uranium (U) and Argon (Ar), respectively. The reverse side (not shown) of each card is blank/empty, while the obverse side contains an information module comprising information about the chemical element represented by the card.

Referring again to FIGS. 1A, 1B, 1C and 1D, the information module of each card shows the following

(i) the element symbol (503) (e.g.: Li, Eu, U or Ar);
(ii) the element name (504) (e.g.: Lithium, Europium, Uranium or Argon);
(iii) the atomic number (or atomic weight) of the element (501) (e.g.: 3, 63, 92 or 18, which is also the card number);
(iv) a category indicator (502) (#1-17, E, G or N), shown encircled;
(v) a series (505) of numbers representing the atomic shell structure of that element (for example 2,1 for Li or 2,8,18,25,8,2 for Eu or 2,8,18,32,21,9,2 for U or 2,8,8 for AR).

The card representing the radioactive element Uranium also has a special indicator (506), i.e., a radioactive symbol as used in the nuclear energy industry. This symbol indicates that the element represented on the card is special, in this case radioactive. It also indicates that the card may be played to influence the game in a way that cannot be done by other cards. Other cards in the deck will have a similar information module, but not necessarily a special indicator.

The category indicator comprises either a symbol or a Letter or a number in the range 1-17, both inclusive. The playing cards are grouped into four distinct categories as follows:

(1) column-substitutable cards (indicated by the column number in the range 1-17, inclusively);
(2) element-substitutable cards (representing elements with atomic numbers 58-71 inclusive indicated by a symbol or a letter E or L);
(3) group-substitutable cards (representing elements with atomic numbers 90-103 inclusive identified by a symbol or a letter G or A); and
(4) noble element cards (identified elements in group 18 identified by a symbol or the letter N).

Thus, a category (1) card represents an element that belongs to the main body of the periodic table and, hence, is not part of the lanthanides (atomic numbers 58-71 inclusive) and actinides groups (atomic numbers 90-103 inclusive). During the game, a playing card with a particular column number as its category indicator can be used to substitute for any other playing card with the same column number. Once all participants have played cards in a particular round, the player who played the card with the highest value (atomic number) has the claim to the cards lying upon the table. That player then attempts various card combinations to form chemical compounds, and claims those cards used in the formation as his/her own. When trying to form a compound, the player may substitute one card (say H) with another card (say Li) in the same column (column-substitutable card). More particularly, if a player holds two cards representing Hydrogen (H) and Oxygen (O), respectively, and a third card representing Lithium (Li), both Hydrogen and Lithium will have “1” as the column number, so the player could use the Lithium (Li) card to represent a second Hydrogen (H) atom to form water (H₂O).

Category (1) card can be combined with any other card representing an element (target element) to represent multiple units of the target element. Here, the group number (1-17) represents the number of units of the target element. For example by combining any card from group 2 can be combined with a card denoting Hydrogen (H) to represent 2H or H₂ in chemical equation or chemical compound formula. Similarly a card representing group (4) can be combined with a card denoting Oxygen (O) to represent 4O or O₄. Thus a card representing hydrogen and a card representing Oxygen and Sulfur together with cards from group 2 and 4 can be used to represent H₂SO₄ (Sulfuric acid).

Category (2) cards identified by the letter ‘E’, encircled, as the category indicator, may be referred to as “element-substitutable” cards. These category E cards represent the Lanthanides group 180 of elements (with atomic numbers 58-71 inclusive), shown in the tables 402/1/2/3/4 of the game board 400. A category (2) card can be used as itself, i.e., as an element with a given atomic number, or to substitute for any number of atoms of a given element type in a chemical compound, i.e., it can be used to represent multiple atoms of the same elements e.g., (H₂, H₃, O₂, O₃, O₄). For example, an element-substitutable card can be used to represent H₂ or O₄ in H₂SO₄.

Category (3) cards may be referred to as “group-substitutable” cards. These category (3) cards represent the Actinides group of elements (with atomic numbers 90-103 inclusive) shown in the tables 402 of the game board 400. A category (3) card is identified by the letter ‘G’ as the category indicator in the information module and can be used as itself, i.e., as an element with a given atomic number, or to substitute for a group of elements that collectively participate in a chemical reaction. For example, a group-substitutable card can be used to represent (OH)₃ in Al(OH)₃.

Category (4) cards may be referred to as the “noble element” cards. These category (4) cards are identified by the letter ‘N’ as the category indicator in the information module and represent the noble gases in column 18 of the periodic table. The element represented by a category (4) card does not participate in chemical reactions under normal conditions and therefore will not be used to create chemical compounds during the game. Thus, these cards have zero value and cannot be used to claim the right to form chemical compounds. By playing this category (4) card, however, a player can fulfill his obligation to participate in a particular turn or round by contributing a worthless (zero value) card while holding onto valuable cards in his hand, i.e., without sacrificing them.

Playing cards which, have the nuclear symbol 506 in the information module (like the uranium card shown in FIG. 1C,), correspond to radioactive elements in the periodic table and have special roles in the game. Just like other playing cards, these “radioactive” cards can be used to represent multiple elements or as column-substitutable cards (category (1)), element-substitutable cards (category (2)) or group-substitutable cards (category (3)), depending upon their position in the Periodic Table. In addition, however, these radioactive cards may be played to nullify the current round of the game, in a sense like a “trump” card used in other card games such as whist.

Thus, a player can “challenge” the other players by playing a radioactive card, thereby declaring his intention to “nuke” (bomb) the round. The subsequent players in the same round of the game each have two options; either to counter the challenge and neutralize the “nuke” attack, or leave it unchallenged by playing any of the cards in hand to fulfill the requirement, in his turn, of placing a card upon the table. If this “nuke” attack is not countered or neutralized, but is left unchallenged, all of the cards played in the round will be set aside from the play and their values will not be used in calculating the score. Typically, a player might try a “nuke” attack if a preceding player played a card with a very high value; unless countered successfully, the nuke attack would spoil the round and stop that preceding player from winning the round. Thus, these radioactive cards may introduce an element of surprise to the game.

To counter this challenge and neutralize the “nuke” attack, a subsequent player in the same round must play another radioactive card having a higher atomic number than the radioactive card used to launch the “nuke attack”.

Any of the other subsequent players, following in their turn in the same round, may play another radioactive card having an atomic number higher than the radioactive card(s) already played to neutralize the “nuke attack”, and so assume the right to claim responsibility for neutralizing the “nuke” attack.

If the attack is neutralized, the player who neutralized the attack (by playing the radioactive card of highest atomic number in the round) can directly claim all the cards as reward, without using any of them to form any chemical compounds. If more than one player neutralized the attack by playing a radioactive card, the player who played the radioactive card with highest value will be the winner of the round and claim all cards of the round as a reward. The player who launched the “nuke attack” and any player(s) who tried to neutralize the “nuke attack” but were “trumped” by a subsequent player playing a higher-value radioactive card, will not get any cards in that round. Thus, the playing of a radioactive card will result in an “all or nothing” round. Radioactive card are identified by a radioactive symbol 506.

The players may be given the option of deciding before the start of the game how many times each player may play a radioactive card during a particular game, the default number of times being once. If the players choose to increase the maximum allowable number, or make it unlimited, the result may be a very chaotic game with a very exciting and unpredictable outcome.

The concepts of skipping a round by playing a joker card, declaring a nuke attack by playing a radioactive card and neutralizing a nuke attack by playing a radioactive card of higher atomic number than what is already played are some of the novel features introduced in the current invention.

Further rules for using the cards in the course of card games embodying the present invention will become apparent from the following description of preferred embodiments.

With a view to resolving disputes, game equipment embodying the present invention may include a reference listing of chemical compounds and the rules then may prescribe that compounds formed during game play must be listed in the reference listing. The following short listing of chemical elements is an example extracted from the on-line encyclopedia Wikipedia™. It will be appreciated that reference might be made, during the game, directly to the Wikipedia™ listing itself, especially if the game is being played using a computer.

Aluminium antimonide—AlSb
Aluminium arsenide—AlAs
Aluminium nitride—AlN
Aluminium oxide—Al₂O₃
Aluminium phosphide—AlP
Aluminium chloride—AlCl₃
Aluminium fluoride—AlF₃
Aluminium hydroxide—Al(OH)₃
Aluminium nitrate—Al(NO₃)₃
Aluminium sulfate—Al₂(SO₄)₃
Ammonia—NH₃
Ammonium bicarbonate—NH₄HCO₃
Ammonium cerium(IV) nitrate—(NH₄)₂Ce(NO₃)₆
Ammonium chloride—NH₄Cl
Ammonium hydroxide—NH₄OH
Ammonium nitrate—NH₄NO₃
Ammonium sulfate—(NH₄)₂SO₄
Ammonium tetrathiocyanatodiammine-
chromate(III)—NH₄[Cr(SCN)₄(NH₃)₂]
Antimony hydride—SbH₃
Antimony pentachloride—SbCl₅
Antimony pentafluoride—SbF₅
Antimony trioxide—Sb₂O₃
Arsine—AsH₃

The cards won during a round can be combined by the winner of the round to form chemical reaction equation by exploiting the special roles assigned to category 1, 2, 3 and 4 types of cards. All cards used in the formation of the chemical reaction equation are earned by the winner as the winning prize.

### DESCRIPTION OF PREFERRED EMBODIMENTS

Goal of Each Player:

The goal of each player is to collect maximum number of non-Joker cards in each round.

Start the Game:

Players each roll one die. The player with the highest roll is the first dealer. Dealer shuffles the cards and distributes 6 cards to each player, one at a time, face down. The remainder of the deck is placed in the middle of the play area, forming the common deck.

First Player:

The first player picks a card from the common deck and discards a non-Joker card from the player's hand by placing it face up in the play area. Player must state aloud the name of the element. Opponents note the type of the card played as the ‘card type of the round’.

Game Play:

Play begins with the player to the immediate left of the dealer, continuing clockwise. Player's turn begins by taking the top card from the common deck. Player's turn ends by discarding a card into the play area. Player must state aloud the name of the element.

End of a Round:

The round ends when all players place one card face up in the play area. Winner of the round is decided as described below. The player to the left of the winner will start the next round. In the case of a nuked round with no winner, player next to the last player starts the next round. The game continues until one player runs out of cards.

Winning Strategies:

Play the highest value card with the card type same as the card type of the round for a chance to win the round. If a player cannot win the round, the player can minimize the loss by playing a Joker card. If a player cannot win the round, the player can attempt to nuke the round by playing a radioactive card (a card with a radioactive symbol) and state the intention for ‘nuke attack’. Once a nuke attack is declared, all remaining players who have not yet played must play a card when their turn for the round comes. A successful nuke attack will spoil the round and all cards in the round will be kept aside until the end of the game. Thus, with a successful nuke attack, nobody is awarded the cards of the round. If the player did not state the intention to declare a nuke attack, the radioactive card should be treated as a regular card. Once a nuke attack is declared, any remaining players of the round can attempt to neutralize the nuke attack by playing a radioactive card of higher value than the card used to declare nuke attack. The player who played the radioactive card with highest value in a round, after a nuke attack, will neutralize the nuke attack and will collect all cards in the round as a reward. A nuke attack will fail if one of the subsequent players in the round (who has not yet played) neutralizes the attack.

Winner of the Round:

In a round with no nuke attack: the player who played card with the highest card value that matches the card type of the round wins the round and gets all cards in the play area. These cards collected by the player will be kept aside as the earned cards by the player (winner of the round) and cannot be used again. In a round with nuke attack declared but not neutralized: no winner for the round. All cards in the play area will be kept aside from the play; no one earns these cards. In a round with a nuke attack declared and neutralized: the player who played the radioactive card with the highest value to neutralize the nuke attack in the round is the winner. The winner earns all cards in the play area for the round. These cards collected by the player (winner of the round) will be kept aside as the earned cards by the player and cannot be used by the player in the coming rounds of the game.

Winner of the Game:

The player with the highest number of non-Joker earned cards at the end of the game wins the game. In the most simple form of the preferred embodiment, player earn all cards that he/she won during the round.

In one variant version of the preferred embodiment, player earn all cards that he/she was able to make use in the compound formula as described below.

In another variant version of the preferred embodiment, player earn all cards that h/she was able to make use in the chemical reaction equation.

Compound Formation Rules:

Compound formation rules are designed to help players recall chemical compound names and formulas. They are valid only in the context of this game. Same card types can be substituted for each other. E.g. H card+Li card+O card can be used to represent H₂O (water). Li card and H card are of same card type—card type 1. Therefore, Li card can be used as an H card and hence can be used to represent H₂O using H card, Li card and O card.

Category (1) card can be combined with any other card representing an element (target element) to represent multiple units of the target element. Here, the group number (1-17) represents the number of units of the target element. For example by combining any card from group 2 can be combined with a card denoting Hydrogen (H) to represent 2H or H₂ in chemical equation or chemical compound formula. Similarly a card representing group (4) can be combined with a card denoting Oxygen (O) to represent 4O or O₄. Thus a card representing hydrogen and a card representing Oxygen and Sulfur together with cards from group 2 and 4 can be used to represent H₂SO₄ (Sulfuric acid).

Element substitutable card (card type E) can represent multiple atoms of the same element. One example is: An E type card+card for Sulfur (S)+Another E type card=H₂SO₄ as one E type card can represent H₂ and another E type card can represent O₄. Another example is: An E type card+card for Oxygen (O)═H₂O as E type card can represent H₂. Group substitutable card (card type G) can represent groups in a compound: E.g. Be card+any card of card type G=Be(OH)₂, as a G type card can represent (OH)₂ group. One cannot create a compound using only card type E and card type G cards (as Element substitutable and Group substitutable cards).

Chemical Reaction Equation Rules:

Chemical Reaction Equation rules are designed to help players recall chemical reaction equations formulas. They are valid only in the context of this game. Players win all the cards used on both sides of a chemical reaction equation: Examples of chemical reaction equations are:

Zn+H₂SO₄=>ZnSO₄+H₂

2Mg+O₂=>2MgO

CH₄+2O₂=>2H₂O+CO₂

2KCLO₃=>2KCL+3O³

N₂+O₂=>2NO

K+NaCl=>KCl+Na

Ba(OH)₂+H₂SO₄=>BaSO₄+2H₂O

Pb(ClO₃)₂+2NaI═>PbI2+2NaClO₃

U═>Th+He

Compound formation rules described above could be applied to complete the chemical reaction equation. If challenged by other players, any reaction equation created thus must be written down and substantiated by a valid reference.

### Alternate Embodiment 1

### Atomic Rummy

Goal of Each Player:

The goal of each player is to collect cards to make complete set(s), forming meaningful patterns on the Periodic Table. The minimum number of cards in each set is 4. Joker cards (card type N) may be used in place of missing cards to complete a set. Some examples of the complete sets are given below.

Winner of the Game:

The game ends when a player claims victory during their turn by making complete set(s) using all their non-Joker cards or when the common deck of cards is empty. A player claims victory by displaying complete set(s) of cards face up in the play area. Cards left in winner's hand that are not part of any complete set must be Joker cards. A card can be part of only one set. If the common deck of cards becomes empty before a player wins, each player displays their complete set(s) of cards face up in the play area. In this case, the player with the least number of non-Joker cards that are not part of any complete set, wins. Each player who did not win counts the number of non-Joker cards that are not part of any complete set. This gives the points by which the player has lost the game.

Start the Game:

Players each roll one die. The player with the highest roll is the first dealer. Dealer shuffles the cards and distributes 10 cards to each player, one at a time, face down. The remainder of the deck is placed in the middle of the play area, forming the common deck. Prior to beginning play, players discuss if a set of four or more cards representing elements with the same element property can be used to represent a winning set (e.g. same physical state (solid, gas, liquid), metal, radioactive, toxic etc).

Game Play:

Play begins with the player to the immediate left of the dealer, continuing clockwise. Player's turn begins by taking a card, either the last card played, or drawing the top card from the common deck. Player's turn ends by discarding a card into the play area. Player must state aloud the name of the element in the card played.

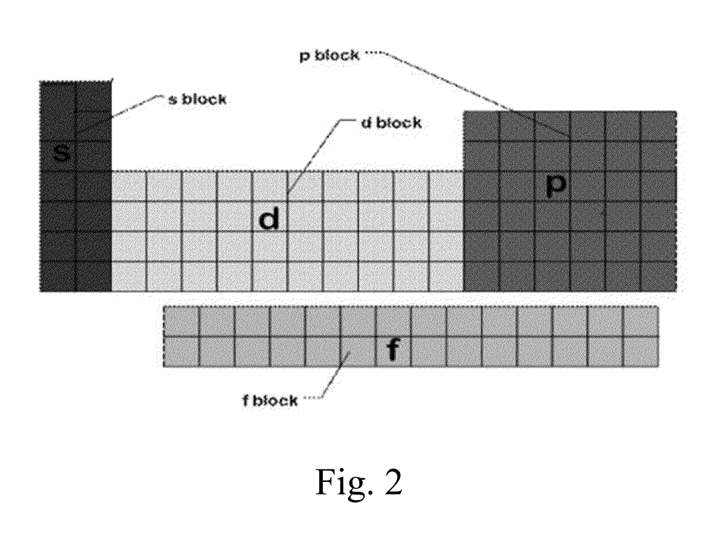

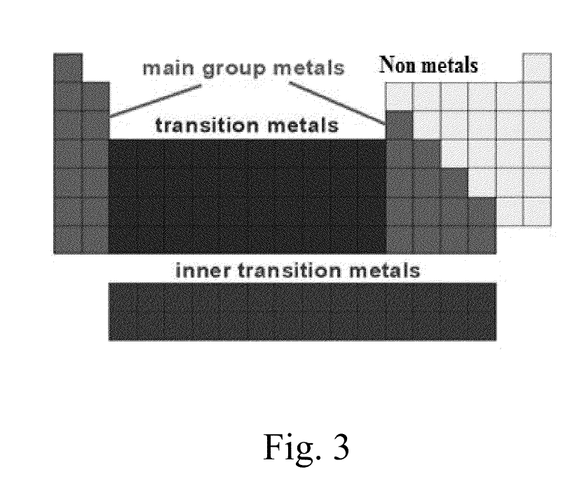

Sets May Include:
1. A set of 4 or more cards of the same card type.
2. A set of 4 or more cards with consecutive card values (atomic numbers).
3. A set of 10 cards that belong to any one of the element blocks on the Periodic Table of Elements. The different blocks on the Periodic Table of Elements are s-block, p-block, d-block and f-block on a Periodic Table of Element as shown in FIG. 2
4. A set of 10 cards from the same category of elements on the Periodic Table of Elements. The different categories of elements on the Periodic Table are ‘main group metals’, ‘non-metals’, ‘transitional metals’ and ‘inner transitional metals’, as shown in FIG. 3
5. A set of 4 or more cards representing elements with the same element property that players have agreed upon before the start of the Atomic Rummy game (e.g. same physical state (solid, gas, liquid), metal, radioactive, toxic etc).

### Alternate Embodiment 2

### Shell Game

Start the Game:

Players each roll one die. The player with the highest roll is the first dealer. Dealer shuffles the cards and distributes 6 cards to each player, one at a time, face down. The remainder of the deck is placed in the middle of the play area, forming the common deck.

First Player:

The first player picks a card from the common deck and discards a non-Joker card from the player's hand by placing it face up in the play area. Player must state aloud the name of the element.

Game Play:

Play begins with the player to the immediate left of the dealer, continuing clockwise. Player's turn begins by drawing the top card from the common deck. Player's turn ends by discarding a card into the play area. Player must state aloud the name of the element.

Each Player:

Players try to make as many Card Groups as possible from the cards in the play area, to win those cards.

The game continues until one player runs out of cards.

Goal of Each Player:

Try to make one or more Card Group(s) using the cards in the play area. The player wins all cards that are used to form the Card Group(s). One card can be part of only one Card Group. These cards collected by the player will be kept aside as the earned cards by the player and cannot be used again.

To form a Card Group, the cards share (give or take) the electrons in their outer shells among them. After sharing, each card in the Card Group will have a completed outer shell (2, 8, 18, 32 depending upon the shell structure of the card). If a player cannot make any Card Group(s), the player can minimize the loss by playing a Joker card.

Winner of the Game:

The player who has the highest number of non-Joker earned cards wins the game.

### Valid Card Groups:

These rules and the definition of Card Groups are designed to help players become familiar with shell structure of elements. They are valid only in the context of this game.
1. A card of card type 1 can be paired with card type 17 to produce a completed outermost shell for both elements; this completed outermost shell has 8 electrons except for H and Li. Examples for valid groups are: (H, Cl), (Na, Cl), (K. I). H has 0 and Li has 2 as the stable outermost shell when grouped with a card type 17 element card.
2. A card of card type 2 can be paired with card type 16 to produce a completed outermost shell for both elements; this completed outermost shell has 8 electrons. Examples for valid groups are: (Be, O), (Mg, S)
3. Card Types 3 to 10 For a card type 3 the two outermost shells together have 11 electrons. In the shell game, the card becomes stable by giving up these 11 electrons, when it is grouped with one element card each from card types 13, 14 and 16. All four of them achieve stable state as follows: card type 3 gives up 11 electrons. Card type 13 takes electrons to make 18, 8 as outer shells. Card type 14 takes 4 electrons to make 18, 8 as its outer shells. Card type 16 takes 2 electrons to make 18, 8 as outer shells. Thus the combination of 4 element cards of types 3, 13, 14, and 16 is a valid Card Group. This valid Card Group of 4 cards is represented as (3, 13, 14, 16) where 3, 13, 14, and 16 are the type of the cards in the group. Similarly, some other valid Card Groups with 18, 8 as the completed outermost shell using card types in the range 4 to 10 are: (4,13,14,15), (5,13,14,15,17), (6,13,14,15, 16), (7,15, 16, 13, 14, 17), (8,13,14,15,16,16), (9,13,14,15,15,16), (10,13,14,14,15,16).
4. Card Types 11 to 17 For a card type 11 the outermost shell has 1 electron. The card can become stable by giving up this 1 electron. When a card type 11 is grouped with a card type 17, both of them achieve stable state as follows: card type 11 gives up 1 electron. Card type 17 takes 1 electron to make 8 electrons in its outer shell. Thus the combination of 2 element cards of types 11 and 17 is a valid Card Group and is represented as (11, 17). Some other valid Card Groups with 8 and 18 as the completed outermost shell using card types in the range 12 to 17 are: (12, 16), (13, 15), (14, 14).
5. Card Types E and G: For card types E (Lanthanides) and G (Actinides), the outermost shells when completed are: 32, 18, 8. To achieve stable state these cards either give up all electrons in these three outermost shells or fill them to complete. Some examples of valid combinations (1 card from each card type) that involve a card of type E or G are: E or G card type giving electrons: (La or Ac card, 13, 14, 15, 16, 16, 17, 2, 2), (Ce or Th card, 13, 14, 15, 15, 16, 17, 2, 2), (Pr or Pa card, 13, 14, 14, 15, 16, 17, 2,2), (Nd or U card, 13, 13, 14, 15, 16, 17, 2, 2); E or G type getting electrons: (Pm or Np card, 10, 12, 15), (Sm or Pu card, 9, 15,12), (Eu or Am card, 8, 15, 12), (Gd or Cm card, 10, 14), (Tb or Bk card, 10, 13), (Dy or Cf card, 10, 2), (Ho or Es card, 10, 1), (Er or Fm card, 10), (Tm or Md card, 9), (Yb or No card, 8), (Lu or Lr card, 7).

### Playing Media

Card games embodying the invention may employ physical media (such as paper, cardboard or plastic cards) or electronic media, such as a personal computer having any suitable operating system, a gaming console (examples include but are not limited to Sony Playstation™, Microsoft Xbox360™ and Nintendo Wii™) or a hand-held personal communication/entertainment device (examples including, but not limited to cell phones, IPods™, Blackberries™).

A computer-based or electronic media version of the learning system or educational game may be played in a networked environment among multiple players located at different physical locations across the network. The present invention is well suited for being played using so-called “siftable cubes” as disclosed in US Published Patent Application No. 20090273560, the contents of which are incorporated herein by reference, and at website http://tacolab.com/projects/Siftables, http://sifteo.com).

Embodiments of the invention can be used by a single player, perhaps as part of self-phased learning or training, using a suitably-programmed personal computer or (electronic media or gaming console instead of another player.

### Novel Aspects of Current Invention:

Mendeleev's Periodic Table of Elements (http://en.wikipedia.org/wiki/Periodic_table) represents the complete set of chemical elements known to mankind that constitute the building blocks of matter in the universe as we know it. Periodic Table of Elements is an essential tool in Chemistry for understanding the properties of chemical elements and compounds. It is an essential component of high school curriculum around the world.
Because of its significance in Chemistry curriculum, several attempts were made in the past to invent alternative ways of teaching Periodic Table of Elements to students, that are more engaging and entertaining. Some of them resulted in Chemistry card games and others in Chemistry board games.
Current invention through claims 1-16 describes an active learning system and a method of using the system in the form of card games to teach students various aspects of the Periodic Table of Elements and individual elements. Examples of the different aspects and attributes covered by these games are: (i) element name (ii) element symbol (iii) atomic number (iv) atomic group (v) radioactivity (vi) noble elements (vii) actinides (viii) lanthanides (ix) element distribution on the Periodic Table (x) chemical compound formation using elements. Thus, the current invention covers the core aspects of the high school Chemistry curriculum on Periodic Table of Elements. Traditional way of teaching this back-bone of Chemistry to school students is through text books. With that, students may not be engaging in learning material beyond simple memorization. In contrast, current invention offers students an engaging and entertaining way of learning about Periodic Table of Elements in Chemistry and chemical compound formation.

Current invention enables students to learn (or teachers to teach) the subject matter of Periodic Table of Elements through a physical model of the Periodic Table and a set of active learning games to facilitate game based learning by manipulating this physical model according to the rules prescribed (active learning process) rather than reading text books. This approach ensures that students work in cooperative and collaborative groups and encourages group participation and group discussions. It also results in students taking increased responsibility for their learning. This is in contrast to the text book based traditional learning process in which the learning is individualized that may result in only memorization.

There were attempts in the past to invent novel ways of teaching Periodic Table of Elements to students through card games as described in our prior art reviews. But these attempts were (i) either incomplete, by not covering the entire Periodic Table of Elements or (ii) misleading through the introduction of fictitious, non-scientific concepts that could potentially mislead the students. Consequently, these attempts were not successful in classrooms to complement or replace textbook based method of teaching (and learning) the Periodic Table of Elements.

The active learning system for teaching Periodic Table of Elements described in the current invention in the form of active learning card game, is novel because of the following reasons:
(i) Unlike attempts described in prior arts, in the current invention provides full coverage of the entire set of elements present on the Periodic Table of Elements and therefore it represents a physical model of the Periodic Table of Elements that can be detached into element cards that can be manipulated through active learning process to help students learn and retain various aspects of the periodic table of elements and the elements.
(ii) Unlike attempts described in prior arts, in the current invention there is a one to one correspondence between the cards and elements on the Periodic Table of Elements. Each element on the Periodic Table of Elements is represented by unique card in the current invention
(iii) Unlike attempts described in prior arts, the information used to execute the games in the current invention is based only on the scientific properties of the elements.
(iv) Unlike attempts described in prior arts, the current invention does not introduce any fictitious or non-scientific concepts through additional cards.
(v) Unlike attempts described in prior arts, the current invention can be used as an active learning system based alternative to traditional text book based teaching/learning of Elements and Periodic Table of Elements in class rooms. The current invention offers a more engaging, entertaining and exciting way of learning about Elements and Periodic Table of Elements, that encourages group participation and group discussion beyond what is achievable through text book based learning.
(vi) Current invention through claims 74-85 is the only card game that is exclusively based on and only on the entire set of 118 chemical elements represented on the Periodic Table of Elements and therefore represents a physical model of the Periodic Table and a set of games to use the model to learn fundamentals of chemistry. The current invention gives player a non-discriminating, equal opportunity to get to know each and every Element on the Periodic Table of Elements through playing the card games.

An advantage of embodiments of the present invention which employ the relatively facile concepts of “column-substitutable”, “element-substitutable” and “group-substitutable” cards to group the elements represented on the Periodic Table of Chemical Elements is that, in contrast to games disclosed in the prior art, they do not need “made-up” cards with no meaning in the domain of chemistry.

Advantageously, preferred embodiments of the present invention are based on the complete set of chemical elements known to mankind that are represented in the Periodic Table of Chemical Elements, whether naturally occurring, artificially created or predicted.

During the course of game play, the players learn aspects of known elements presented in the Periodic Table of Chemical Elements, such as the atomic weight, atomic number, name and symbol, the position in the Mendeleev Periodic Table of Chemical Elements and what the position means, and/or the valence electron shell structure, simply by exposure to these aspects while playing the game. In addition, like a child building a language vocabulary through word games, the players will be exposed to several chemical compounds through the game. By repeatedly playing the game, and competing and interacting, the players will be exposed to, and may acquire, knowledge about hundreds of existing known chemical compounds, radioactive elements and noble gases.

### Inventive Steps

The main obstacle is the design and development of such games. current invention overcome this obstacle to provide an active learning (requiring active group participation, non-text book based) system and associated method in the form of card game(s) to teach/learn the Periodic Table of Elements, its characteristic features and Element distribution patterns, various properties of the entire set of chemical elements on the Periodic Table as well as compound formulae and atomic shell structure of individual elements.—

The basic requirement for learning about chemical elements and Chemistry in a gaming environment is the need to represent each element known to mankind (i.e. to represent elements in the Periodic Table of Elements). Learning about chemical compound formulae is an essential part of learning about elements and Chemistry. Attempts were made in the past to invent compound formation games as described in the prior art. But these attempts were crippled by the fact that many of the common compounds are made of multiple copies of same element(s). For example, to represent Sulfuric Acid (H₂SO₄) formula, we need the use of four Oxygen cards. Under normal conditions this means that in any compound formation game using the entire set of elements represented on the Periodic Table of Elements requires 4×118=472 cards (ignoring the fact that we could have more than 4 copies of the same element in many compounds) which is unrealistic.

Attempts were made to overcome this problem. For example, Formulon Chemistry card game (as described in the prior art review) make use of non-element cards such as element ions and 20 multipliers (by two or three). This introduces many cards that have no real meaning in the context of elements and Chemistry. The introduction of ions and multipliers makes the game more complex and confusing. Because of these limitations attempts to make a Chemistry compound formation game were not successful in formulating even some of the common compounds in the past.

Through current invention, we invented the concepts of (i) column substitutable card, (ii) element substitutable card and (iii) group substitutable card, to overcome this limitation. By making use of these concepts, players can use one element in any column to represent itself or any other card in the same column. For example, a player can use a Hydrogen (H) card, a Lithium (Li) card and an Oxygen (O) card to represent water provided the player is capable of correctly identifying the compound as water and correctly state its formula as H₂O. Similarly an Element in the Lanthanide group can be used to represent itself or multiple units of the same element. Thus during a compound formation game, a player can use two Lanthanide cards (with symbol E) and a Sulfur (S) card to represent H₂SO₄ provided the player is capable of correctly identifying the compound as Sulfuric acid and correctly state its formula as H₂SO₄. Through these games, players challenge each other in their understanding of complex compound names and formula such as Sodium ferrocyanide-Na₄Fe(CN)₆ or Uranyl hydroxide-(UO₂)₂(OH)₄.

The current invention does not have any fictitious cards. Current invention is the only card game that is exclusively based on and only on the entire set of 118 chemical elements represented on the Periodic Table of Elements. Each element on the Periodic Table of Elements has its own card. With that, along with the rules of the game the current invention gives player a non-discriminating, equal opportunity to get to know each and every element on the Periodic Table of Elements. No other Chemistry card game was able provide such extensive compound formation capabilities. This inventive approach expands the horizon of player's capability to formulate complex chemical compounds with the use of column substitutable, group substitutable and element substitutable cards. At the same time, potential confusion that could result from the use of such substitutable card is totally eliminated by introducing the rule that any compound formation is valid only if the player can correctly state the name of the element and its chemical formula that (if challenged) could be substantiated by any source of reference.

The active learning system introduced through claims 74-85 is a game that deals with one of the fundamental, essential and complex subject matter in high school curriculum around the world. Fun is an essential component of any game. If there is no fun, there is no game. Being aware of this reality, we have used some inventive steps in this active learning system to ensure fun, unpredictability and opportunities for challenge to make learning more engaging, entertaining and exciting. Some of these inventive steps as identified in claims 74-85 are: (i) Reducing the loss in a round by playing a joker card, (ii) spoiling a round by declaring a nuke attack and (iii) neutralizing a nuke attack by playing a higher value radioactive card, thereby trying to win all cards in the round.

Rummy is a popular card game played around the world. Even small children can play this game as the only skill required is ability to do pattern matching and completion. Adaptation of this popular Rummy game to teach patterns, groups and properties represented on the Periodic Table of Elements is another inventive step used in this invention. Atomic Rummy is one of the simplest card games that can be played by even an 8 year old or someone with no knowledge of Chemistry and Periodic Table of Elements, using the current invention claims 74-85. By playing this fun game each player gets to know about Periodic Table of Elements, its regions, position of different elements, element groups etc. Through this inventive steps, the game could attract any player (of any age, background, and knowledge level) resulting in they becoming more and more familiar with the magical world of Periodic Table of Elements, chemical elements and chemical compounds.

### INDUSTRIAL APPLICABILITY

Active learning educational card games embodying the invention facilitate the goal of learning the vast field of chemistry encapsulated by the Periodic Table of Chemical Elements. Advantageously, embodiments of the present invention can be used by players at all skill levels, from beginners with no knowledge of chemistry to those players with expert knowledge in chemistry.

Although preferred embodiments of the invention have been described and illustrated in detail, it is to be clearly understood that the same are by way of illustration and example only and not to be taken as delimiting the combinations of features necessary to implement the invention, the scope of the present invention being limited only by the appended claims.

### CITATION LIST

### Patent Literature

EP0023687, US20080284104, U.S. Pat. No. 7,490,834

### Non-Patent Literature

http://extension.oregonstate.edu/catalog/4h/4-h02591.pdf
http://www.newmedia.org/game-based-learning—what-it-is-why-it-works-and-where-its-going.html
http://www.ncbi.nlm.nih.gov/pubmed/21592018
http://gsi.berkeley.edu/teachingguide/sections/active.html
http://extension.oregonstate.edu/catalog/4h/4-h02591.pdf
http://www.iupac.org/publications/pac/1988/pdf/6003x0431.pdf
“A handbook of game design” by Henry Ellington, Eric Addinall and Fread Percival, 1982. Kogan Page, London, Nichols Publishing Company, New York,

1. An active learning educational card game comprising a set of cards and rules for playing at least one card game using said set of cards, each of said cards representing a respective one of the chemical elements listed in the Periodic Table of Chemical Elements and carrying information about said one of the chemical elements, together forming a detachable physical model of the Periodic Table of Chemical Elements, the rules prescribing for cards to be distributed to the players who, in their turns in a particular round of the game, to skip the round by playing a card of pre-defined type, or to spoil a round by declaring a nuke attack by playing a card of pre-defined type or to neutralize a nuke attack in progress by playing a card of pre-defined type or attempt to earn cards by playing card of highest value of a pre-defined type and optionally use cards collected by the player to form pre-defined patterns on the Periodic Table of Elements or to form chemical compounds formulas or to balance the ionic equation representing chemical reactions, points being scored according to the value of the cards earned.

2. A card game according to claim 1, wherein the rules define one or more subsets of the cards and prescribe to indicate a card with no value or to act as a placeholder for another element or to represent multiple copies of elements or to substitution of cards belonging to the same subset when forming said chemical compounds or when balancing the equation representing chemical reactions.

3. A card game according to claim 2, wherein said one or more subsets comprise a column-substitutable subset of cards listed in the same column of the Periodic Table of Chemical Elements, and the rules prescribe for substitution of cards belonging to said column-substitutable subset when forming said chemical compounds.

4. A card game according to claim 3, wherein each card in said column-substitutable subset carries a number in the range from 1 to 17, inclusive identifying the column on the Periodic Table, indicating that the card can be used to replace any element in a compound, provided the element belongs to the column on the Periodic Table identified by said number.

5. A card game according to claim 2, wherein one of said one or more subsets comprises an element-substitutable subset of cards which can be substituted on an individual basis and the rules prescribe for substitution of the cards of said element-substitutable subset element-for-element when forming said chemical compounds.

6. A card game according to claims 5, wherein one of said subsets comprises cards each carrying an indicator indicating that the card can be used to represent a plurality of any given element when forming said chemical compounds.

7. A card game according to claims 2, wherein one of said subsets comprises cards each carrying an indicator indicating that the card can be used to represent a plurality of any given group of elements when forming said chemical compounds.

8. A card game according to claims 2, wherein one of said subsets comprises cards each carrying an indicator indicating that the card can be used to represent a ‘joker’ or place holder for any given element when forming said chemical compounds.

9. A card game according to claim 1, wherein at least one of the cards carries an indicium and the rules prescribe for the playing of the indicium-carrying card to influence the progress of the game in a prescribed way.

10. A card game according to claim 9, wherein the rules prescribe for the indicium-bearing cards to negate or trump other cards played during that round, whether before or after the indicium-carrying card.

11. A card game according to claim 10, wherein the rules prescribe for the radioactive indicium-bearing cards to declare a nuclear attack on all cards played during that round, whether before or after the radioactive indicium-carrying card.

12. A card game according to claim 9, wherein the set of cards includes one or more additional indicium-carrying cards and the rules prescribe for one or more players to play one of the additional cards in the same round of the game, the indicium-carrying card whose chemical element has the higher or highest atomic number negating the or each indicium-carrying card already played in that round.

13. A card game according to claim 12, wherein the set of cards includes one or more additional radioactive indicium-carrying cards and the rules prescribe for one or more players to play one of the radioactive cards in the same round of the game, the radioactive indicium-carrying card whose chemical element has the higher or highest atomic number negating the or each radioactive indicium-carrying card already played in that round to neutralize the nuclear attack.

14. A card game according to claim 9, wherein the indicium indicates that the element is radioactive.

15. A card game according to claim 14, wherein the indicium comprises an icon as used to warn of radioactive material.

16. A card game according to claim 3, wherein each card in said column-substitutable subset carries a number in the range from 1 to 17, inclusive identifying the column on the Periodic Table, indicating that the card can be placed along with a target card to represent a plurality of the element represented by the target card in chemical compound formula or chemical equilibrium equations.
